(19) United States
(12) Patent Application Publication
(10) Pub. No.: US 2017/0182918 A1
(43) Pub. Date: Jun. 29, 2017

(54) IN-PROCESS LASER HARDENING/FORMING OF VEHICLE SEAT STRUCTURES AND COMPONENTS

(71) Applicant: Johnson Controls Technology Company, Plymouth, MI (US)

(72) Inventors: Mark Anthony HARRIS, West Bloomfield, MI (US); Daniel J. SAKKINEN, Highland, MI (US)

(21) Appl. No.: 15/302,060

(22) PCT Filed: May 22, 2015
(86) PCT No.: PCT/US15/32150

§ 371 Date: Oct. 5, 2016

Related U.S. Application Data
(60) Provisional application No. 62/002,270, filed on May 23, 2014.

(51) Int. Cl. B60N 2/68; C21D 1/09; C21D 1/58; B60N 2/22; B21D 22/02; B21D 47/00; B21D 53/88; B60N 2/07; C21D 9/00; C21D 1/673

(52) U.S. Cl. CPC B60N 2/68; C21D 9/0068; C21D 1/09; C21D 1/58; C21D 1/673; B21D 22/02; B21D 47/00; B21D 53/88; B60N 2/0722; B60N 2/22

(57) ABSTRACT

A component formation and hardening process, and component (18, 30, 32, 36 and 50) made therefrom are provided. The process includes providing a steel blank (10) and inserting the blank (10) into a press (14), preliminarily stamping the steel blank (2) using a stamping press to form a preliminarily stamped intermediate component (22) and laser hardening (3, 3′) the preliminarily stamped intermediate component in selected regions of the stamped component. Subsequent to the step of laser hardening, the preliminarily stamped intermediate component is further stamped (4) to form a stamped component (18). The stamped component (18) is then ejected (5) from the stamping press as a stamped component with selectively hardened regions. The component made by the process has a defined load path based on regions that have been hardened and regions that retain the material characteristics.

### CROSS REFERENCE TO RELATED APPLICATIONS

This application is a United States National Phase Application of International Application PCT/US2015/032150 filed May 22, 2015 and claims the benefit of priority under 35 U.S.C. §119 of U.S. Provisional Application U.S. 62/002,270 filed May 23, 2014, the entire contents of which are incorporated herein by reference.

### FIELD OF THE INVENTION

The present invention relates to a process for forming components such as stamped parts and stamped bent parts and more particularly to a process for forming stamped parts that have desired geometries with strengthened regions corresponding to expected loads.

### BACKGROUND OF THE INVENTION

Components such as automotive components and particularly automotive seat structure components are advantageously formed of one or more shaped parts such as stamped parts. The sheet metal from which the part is to be made is stamped in a stamping press using a stamping die (tooling). Particularly, sheet blanks are subjected to one or more stamping processes to form stamped parts. One or more stamped parts are used to form an automotive structure or component. Based on the expected loads, the parts may be required to be formed as complex geometric shapes with complex sections and multiple parts that must be joined.

Heat treatments are known for changing the characteristics of metal parts. However, with stamping processes it is difficult to selectively apply heat treatment to particular areas of a formed automotive seat structure or component during the stamping process.

### SUMMARY OF THE INVENTION

It is an object of the invention to provide the ability to selectively apply heat treatment to discrete particular areas of a formed automotive seat structure or component for load management.

According to the invention, a component formation process is provided comprising the steps of providing a steel blank, preliminarily stamping the steel blank using a stamping press to form a preliminarily stamped intermediate component and laser hardening the preliminarily stamped intermediate component in selected regions of the preliminarily stamped component. The laser hardening is followed by either further preliminarily stamping, further laser hardening or a final stamping to form a stamped component. The stamped component is ejected from the stamping press as a stamped component with selectively hardened regions and non-hardened regions.

The laser hardening may advantageously be provided by directing a laser beam at the preliminarily stamped intermediate component at a laser hardening station that is a separate station from the stamping press. The step of stamping the preliminarily stamped intermediate component to form a stamped component, may be carried out in a stamping press that is different from the stamping press used for preliminarily stamping the steel blank.

The laser hardening may advantageously be provided by directing a laser beam at the preliminarily stamped intermediate component with a laser output in or supported adjacent to a tool of the stamping press. The stamping press may also comprise additional laser outlets in the tool of the stamping press, the laser outlets being supplied with a radiation source from one or more lasers.

The heating and cooling may be regulated as to location, duration and degree. The power of the laser may be varied and moved and sized as needed. Cooling techniques may be used to change the rate and set the duration of cooling. A quenching operation may follow laser hardening or may follow stamping. Subsequent to the step of laser hardening the preliminarily stamped intermediate component may advantageously be subjected to an oil quenching operation. The oil quenching operation may advantageously comprise selectively applying quenching oil to the regions of the component that were subjected to the laser hardening.

The step of stamping the preliminarily stamped intermediate component, to form a stamped component, may advantageously be followed by quenching with the stamped component in a die of the stamping press. Particularly, an in die quenching operation may be used.

According to another aspect of the invention, a component is formed according to the method of the invention. The component has predefined hardened areas and predefined areas that have not been hardened. The component is particularly an automotive component formed by the process according to the invention.

The process is used to provide a stamped component that is one of an automotive seat recliner side member, an automotive seat recliner B bracket, an automotive seat track rail; and RR structural components, recliner and tracks components.

The selectively hardened regions may advantageously be at or adjacent to bend portions, openings and regions to be subjected to greater loads than adjacent non-hardened regions with the selectively hardened regions defining a predetermined load path.

The formation of particular geometries, including bend portions, curved portions, flanges, teeth, edge borders and openings may be facilitated by a laser formability process, wherein at least one of the steel blank and the preliminarily stamped intermediate component is subjected to a laser heating to change a formability of the at least one of the steel blank and the preliminarily stamped intermediate component. The laser beam may advantageously be directed at selective regions of the at least one of the steel blank and the preliminarily stamped intermediate component to soften the selected region prior to a subsequent stamping of the at least one of the steel blank and the preliminarily stamped intermediate component. In particular, prior to at least one of the step of preliminarily stamping the steel blank and stamping the preliminarily stamped intermediate component, a laser beam is directed at a selected region of at least one of the steel blank and the preliminarily stamped intermediate component to soften the selected region of the at least one of the steel blank and the preliminarily stamped intermediate component. The selected region of the at least one of the steel blank, and the preliminarily stamped intermediate component is softened.

The laser hardening may be a plurality of laser hardening steps the laser hardening steps may each be followed by one of a plurality of stamping steps. A plurality of laser softening steps may each precede one of a plurality of stamping steps.

The invention allows for the mass of the component to be lowered and allows the performance of a vehicle seat structure or vehicle components to be improved by selectively heat treating sections for load management. The invention provides selected laser-hardened regions and adjacent non-hardened regions. Characteristics of the non-hardened regions remain unchanged whereas the laser-hardened regions are relatively strengthened. The invention replaces conventional methods of load management that use complex geometric shapes & sections.

According to another aspect of the invention, a stamped steel or steel alloy structural component is provided comprising one or more edges and at least one of a bend portion with a selectively laser-hardened region at or adjacent to the bend portion an opening passing through the stamped steel structural component with a selectively laser-hardened region at or adjacent to the opening and a load path region with selectively laser-hardened region at or adjacent to the load path region, the laser-hardened region defining a predetermined load path in the load path region. The laser-hardened region is advantageously adjacent to at least one region that has not been subjected to laser hardening.

Regions adjacent to the selectively laser-hardened region define one or more deformation zones which deform in a predetermined manner upon being subjected to a predetermined load. The load path regions may be at the laser-hardened region and advantageously extend between support locations of the component. The defined load paths have regions that have been hardened and regions that retain the material characteristics.

The invention is particularly advantageous as to automotive parts, and particularly automotive vehicle seat components. Automotive seat structures or components are provided according to the invention that exhibit predictable and repeatable load path performance with improved part geometry. Automotive seat structures or components are provided according to the invention with a 30% mass decrease and cost decrease from a conventional design. This mass and cost decrease allows for a conservation of structural and/or functional requirements.

According to the invention, automotive seat structures or components may be created and designed as a monolithic component with multiple phase microstructures and mechanical properties. The seat structure parts may have defined hardened regions and defined regions that still have the original strength/hardness characteristics of the material. Further, the stamping of the part may be facilitated by selectively heating regions of the blank or the preliminarily stamped intermediate component.

The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

FIG. 1 is a view showing in-process laser hardening steps of the process according to the invention, including possible alternative steps;

FIG. 2 is a perspective view showing a seat in the region of a seat base with a B bracket and a recliner connection with particular areas which are strengthened according to the in-process laser hardening process of the invention;

FIG. 3 is a partial perspective view of a motor vehicle seat railing with regions that are strengthened according to the in-process laser hardening process of the invention;

FIG. 4 is a perspective view showing a recliner frame structure with particular areas which are strengthened according to the in-process laser hardening process of the invention;

FIG. 5 is a side view showing a B bracket with particular areas which are strengthened according to the in-process laser hardening process of the invention;

FIG. 6A is a perspective view showing a lift sector with particular areas which are strengthened according to the in-process laser hardening process of the invention;

FIG. 6B is a perspective view showing the lift sector with the highlighted area strengthened from the selected areas of FIG. 6A having been subjected to the laser hardening process of the invention;

FIG. 7 is a partial perspective view of a motor vehicle seat railing with regions that have been selectively strengthened according to the in-process laser hardening process of the invention;

FIG. 8A is a perspective view showing a side recliner frame component with particular areas which are strengthened according to the in-process laser hardening process of the invention;

FIG. 8B is a perspective view showing the side recliner frame component with the highlighted area strengthened from the selected areas of FIG. 8A having been subjected to the laser hardening process of the invention;

FIG. 9 is a diagram showing elongation and tensile strength characteristics and properties of interest according to the invention;

FIG. 10 is a diagram showing metal properties for selected steel materials;

FIG. 11 is an experimental image (left) compared to a finite element analysis (FEA) model (right);

FIG. 12 is an experimental image (left) compared to a finite element analysis (FEA) model (right);

FIG. 13 is a diagram (top) showing changes in hardness of the base metal for an area treated with the laser hardening process of invention, relative to untreated areas at each side of the treated area, with the bottom portion of the view showing the treated area relative to the adjacent untreated areas; and

FIG. 14 is a diagram (top) showing changes in hardness of the base metal for two areas treated with the laser hardening process of the invention, relative to untreated areas in between the treated areas and at each side of the treated areas, with the bottom portion of the view showing the treated areas relative to the adjacent untreated areas.

### DESCRIPTION OF THE PREFERRED EMBODIMENTS

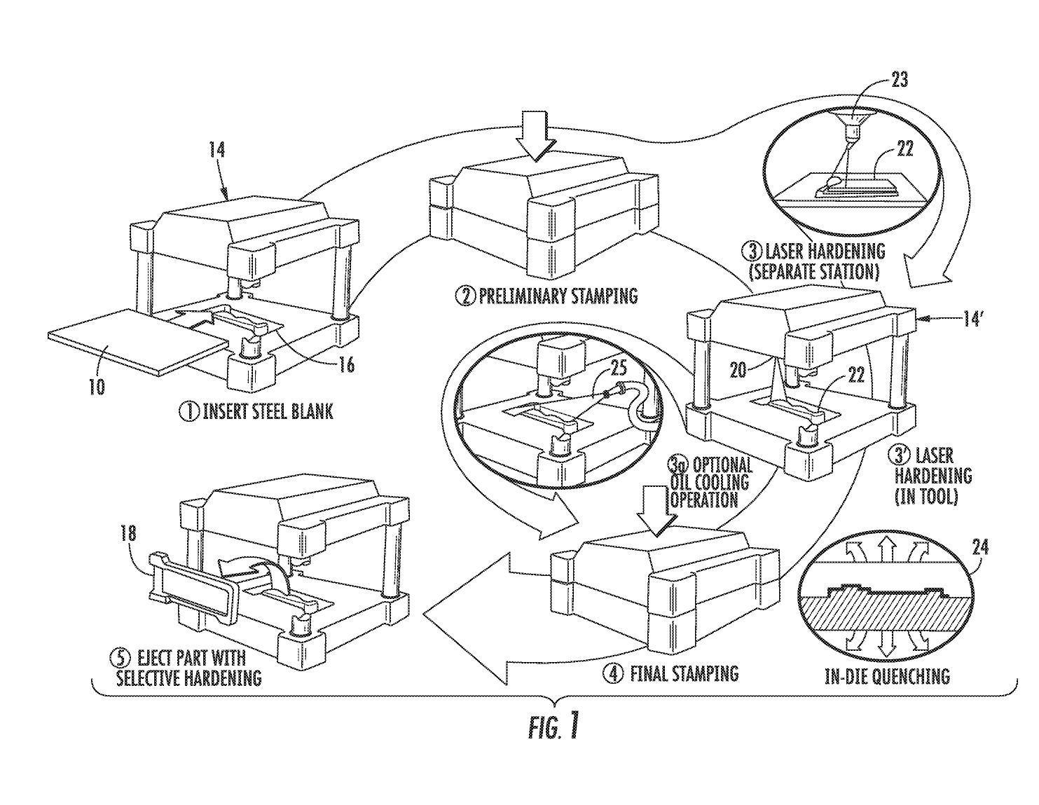

Referring to the drawings, FIG. 1 shows process steps, designated 1-5, according to the inventive in-process component formation with a laser process of the invention. Selective laser hardening is used to selectively apply heat treatment to particular areas of a formed or partially formed automotive seat structure or component. The laser hardening is used for selective strengthening of the component, to provide load management and to provide component parts with simpler/lighter configurations that still have sufficient strength.

Step 1 involves providing a steel blank 10 and inserting the steel blank 10 into a stamping press 14 using a stamping die (tooling) 16. The stamping press 14 may be a conventional stamping press. In the alternative, the stamping press may be a stamping press 14′ including one or more laser outlets 20, for laser hardening, with the laser outlet 20 provided in the stamping press 14′ and/or tool, such as in a protective recess of the tool 16. The laser outlet 20 may also be attached to the stamping press 14′, or may be attached adjacent to the tool 16 and may be moved into and out of position for use, or may be moved through a use area. If the stamping press 14 is used for step 1, the process uses two different stamping presses 14, 14′ or removes the preliminarily stamped component from the stamping press 14 for laser hardening and then returns it to the stamping press 14. In the alternative, if the stamping press 14′ is used including a laser outlet 20, for laser hardening, that is provided in, at or adjacent to the tool 16, the process may instead be executed wherein the stamped component may be fully processed within the stamping press 14′ with the laser outlet 20.

At step 2, the stamping press 14/14′ provides a preliminary stamping. This forms a preliminarily stamped intermediate component 22. The preliminary stamping 2 forms the shape/geometry of selected regions—regions which are to be selectively hardened. The preliminarily stamped intermediate component 22 is then subjected to laser hardening via step 3. According to one variation of the process of the invention, the preliminarily stamped intermediate component is removed from the stamping press after stamping—step 2—and is moved to a separate station for laser hardening—step 3. With this, the selected regions are subjected to the heat of the laser treatment to provide a selective hardening of these particular selected regions. Other regions of the preliminarily stamped intermediate component are not subjected to the laser hardening. This provides a selective hardening of portions of the preliminarily stamped intermediate component. Advantageously, the portions which have been hardened have already been stamped, to fully or essentially provide a final shape/geometry.

As an alternative, the laser hardening of step 3′ is provided with the preliminarily stamped intermediate component 22 still in the stamping press. With the laser hardening of step 3′, the stamping press is a stamping press 14′ including one or more laser outlets 20, for laser hardening in, at, or adjacent to the tool 16. The laser hardening may be conducted without moving the preliminarily stamped intermediate component 22 from the stamping press. The stamping press 14′, including a laser outlet 20, may include a plurality of laser outlets, to provide laser hardening at numerous different selected regions. The laser outlets may be supplied by one or more lasers 23 (via optical fibers). With this, the selected regions are subjected to the heat of the laser treatment to provide a selective hardening of these particular selected regions. Other regions of the preliminarily stamped intermediate component are not subjected to the laser hardening. This provides a selective hardening of portions of the preliminarily stamped intermediate component. Advantageously, the portions which have been hardened have already been stamped, to fully or essentially provide a final shape/geometry.

The steps 3 or 3′ may be followed by an optional oil quenching operation 3a. The oil quenching operation 3a includes selectively applying quenches (quenching media), in particular oil 25 to selected locations, to further affect the hardness attributes (material attributes) of the preliminarily stamped intermediate component. The oil quenching operation 3a may provide a specific and directed quenching of specific regions or may subject the overall preliminarily stamped intermediate component to oil quenching at a rate and for a duration. Other quenches may be used including air, oil and in die quenching 24 as shown in FIG. 1.

The process then proceeds to subsequent preliminary stamping operations (and further laser hardening operations) or to the final stamping step 4. This final stamping 4 can impart the final shape of a stamped component. Advantageously, the stamping includes an in-die quenching, whereby heat generated during stamping is quickly dissipated to provide better characteristics for the final stamped component. Subsequently, the component part 18 is ejected at step 5, with the component part 18 having selected regions which are hardened and also having other regions which have not been subjected to the laser hardening.

The automotive stamped steel structural component of the invention comprises one or more selectively laser-hardened regions and regions that are not laser-hardened. The selection of the regions and the selective application of the laser hardening advantageously may include a methodology in which regions are chosen to manage load paths and to strengthen known regions which require strengthening, such as regions adjacent to openings, narrow edge regions (such as teeth flanges), edge borders, curved and bent portions and similar known areas which require strength due to the geometry and the expected load. Additionally, load paths may be managed to provide predictable and repeatable responses of the component to defined loads. The regions may be selected to provide predetermined deformation (bending/buckling) under directed loads related to a vehicle crash. Load paths may even be directed to cause particular failure or to channel directed loads in selected directions, such as strengthened portions or assemblies of the vehicle seat or vehicle structure.

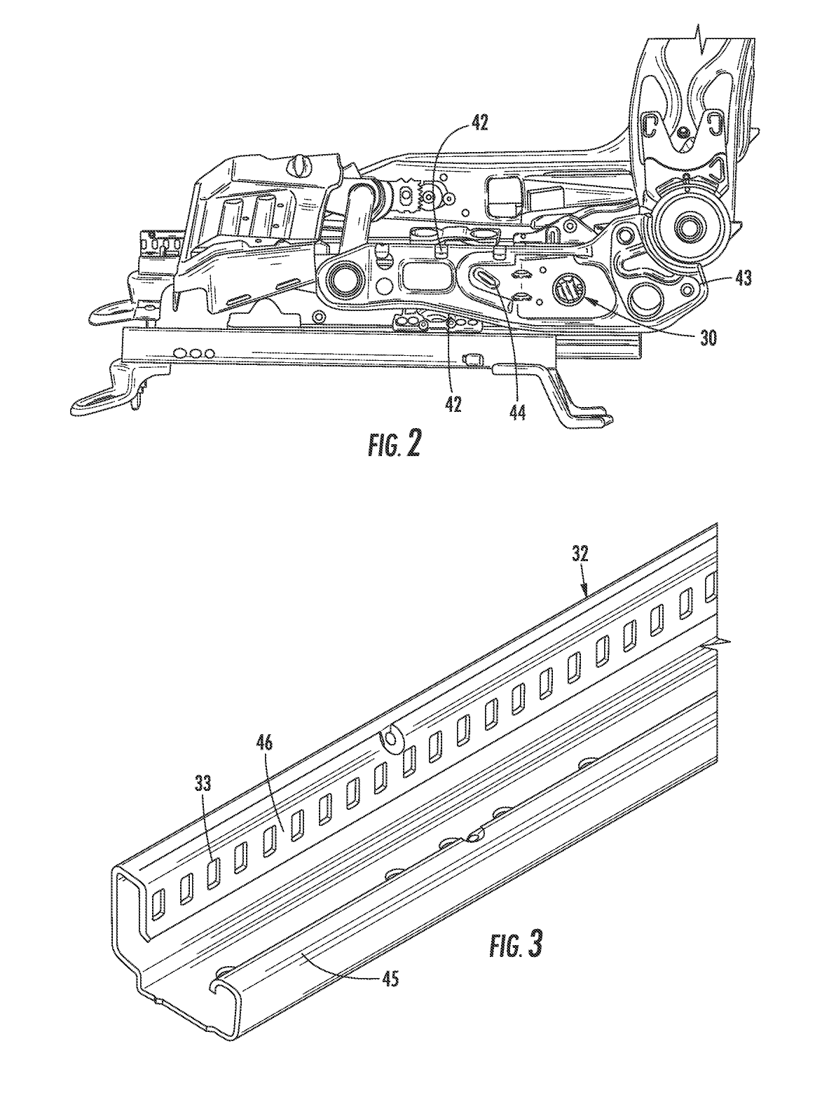

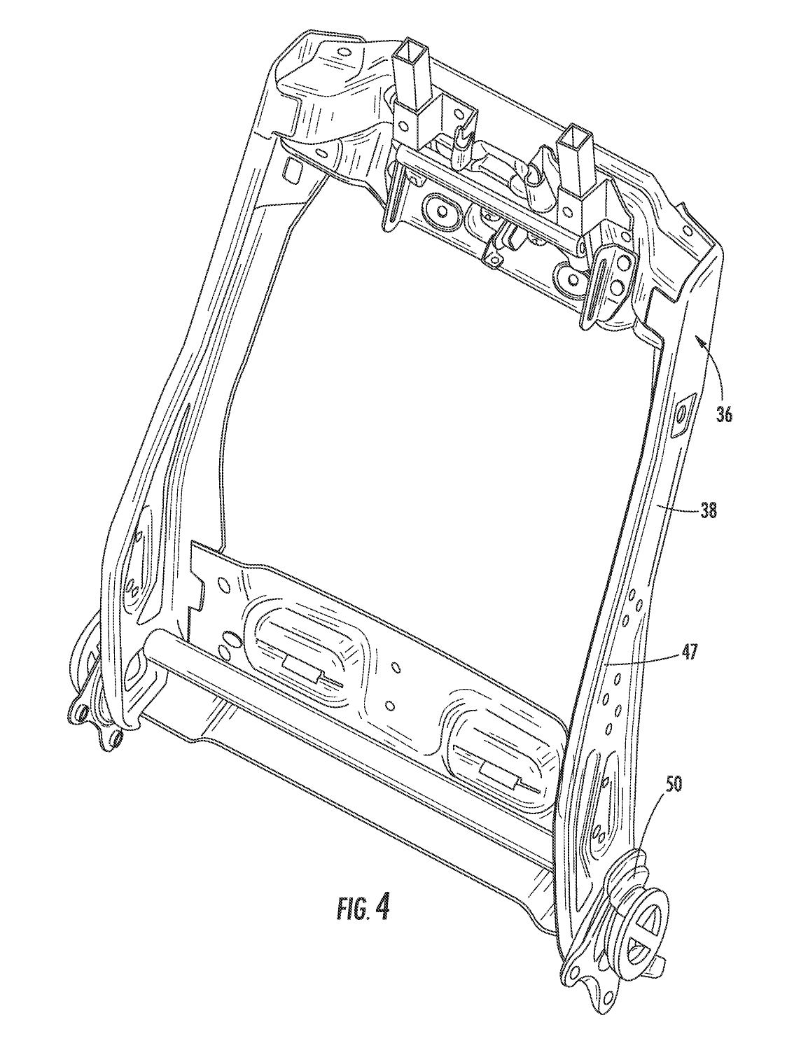

FIG. 2 shows a seat portion and recliner portion of an automotive vehicle seat including a stamped component 30 providing strengthening in the area of the fitting/recliner. The component 30 is a B bracket. Regions 42 are selected as laser-hardened regions, particularly following the bend and edge border of the stamped component 30 and allowing loads to be directed towards supporting locations at the ends of the bracket 30. A region 44, with a bended protruding portion may be selected, particularly to direct loads in the region. FIG. 3 shows a track rail component 32 of an automotive vehicle seat. Regions 45 are selected as laser-hardened regions, particularly to strengthen the bend region. Regions 46, adjacent to the openings 33, may be selected to improve the strength of the marginal portions at each side of the openings 33. FIG. 4 shows a recliner frame or recliner portion 36 of a vehicle seat. The recliner frame includes several components including side members 38 which are formed as stamped components. Regions 47 are selected as laser-hardened regions, particularly to strengthen the bend region, but also to direct load and to strengthen openings. The recliner portion 36 cooperates with fittings and other stamped components and groups of stamped components which have laser-hardened regions. A lift sector 50, which pivots and includes teeth 52 can particularly be strengthened in the region of the teeth to provide additional strength.

FIG. 5 shows the component 30 with the selected regions 42, 43, 44 which have been laser-hardened. The selected regions 42 are at bordering edges with and bends in the component 30. These regions 42 strengthen the bent edge and also direct forces (form a load path) between the supported ends at connection locations of the component 30. The load paths may direct loads in a region adjacent to the fitting and the recliner. The selected regions 43 reinforce openings 40 at connection locations and selected regions 44 reinforce a bent and raised portion and direct loads in a middle section of the component 30. Other regions are not hardened. The selectively hardened regions and non-hardened regions define one or more predetermined load paths. In particular, the B bracket is formed according to the invention wherein portions (regions) have been selectively hardened. This provides a strengthening of particular regions of the B bracket. The strengthening is provided allowing for a reduction of material (mass) and involves less complex geometric shapes and sections. In combination with the one or more stamping steps, with the one or more laser hardening steps, one or more laser softening step may also be provided.

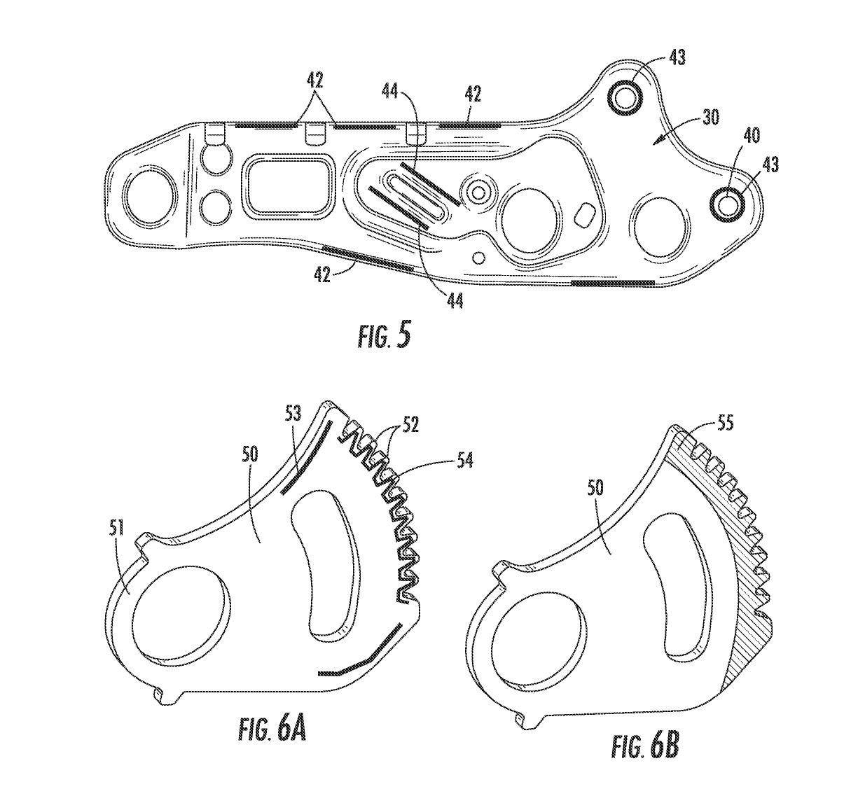

FIG. 6A shows the lift sector component 50 with the selected regions 53 and 54 which have been laser-hardened. The selected regions 53 border edge areas of the component 50. These regions 53 strengthen the edge and also direct forces (form a load path) between the supported end 51 and the teeth engagement end of teeth 52 of the component 50. The selected regions 54 are at edge areas of the teeth 52. As shown in FIG. 6B, the one or more laser hardening steps, that harden the selected regions 53 and 54, provide a strengthened region 55 of the lift sector component 50.

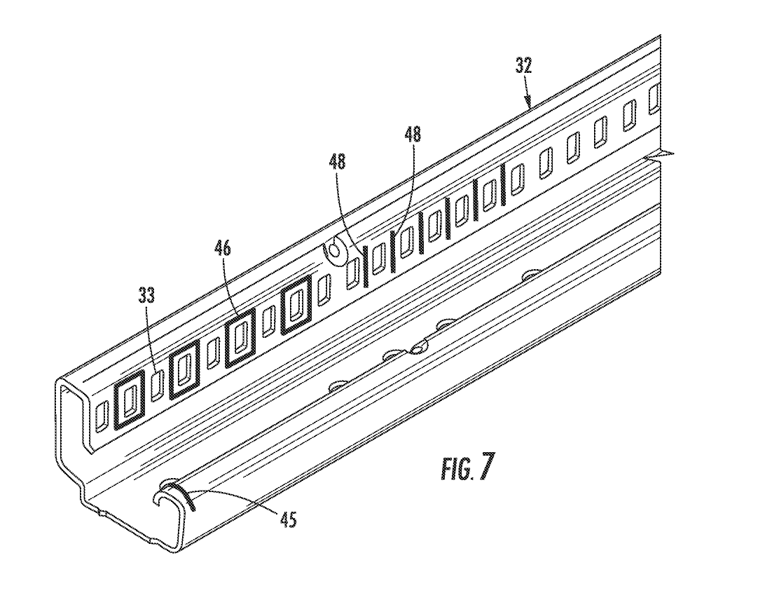

FIG. 7 shows the track rail component 32 of an automotive vehicle seat with the selected regions 45, 46 and 48 which have been laser-hardened. The hardened regions 45 are at or adjacent to bend portions. The hardened regions 46 fully surround the respective openings 33. The laser-hardened regions 48 are at each lateral side of the respective openings 33. Each of the openings may have lateral laser-hardened regions 48 or may each have hardened regions 46 fully surrounding the respective openings 33. A mix of lateral laser-hardened regions 48 and hardened regions 46 may be employed. The selectively laser-hardened regions have been selected as being subjected to greater loads than adjacent non-hardened regions. The selectively hardened regions and non-hardened regions define one or more predetermined load paths.

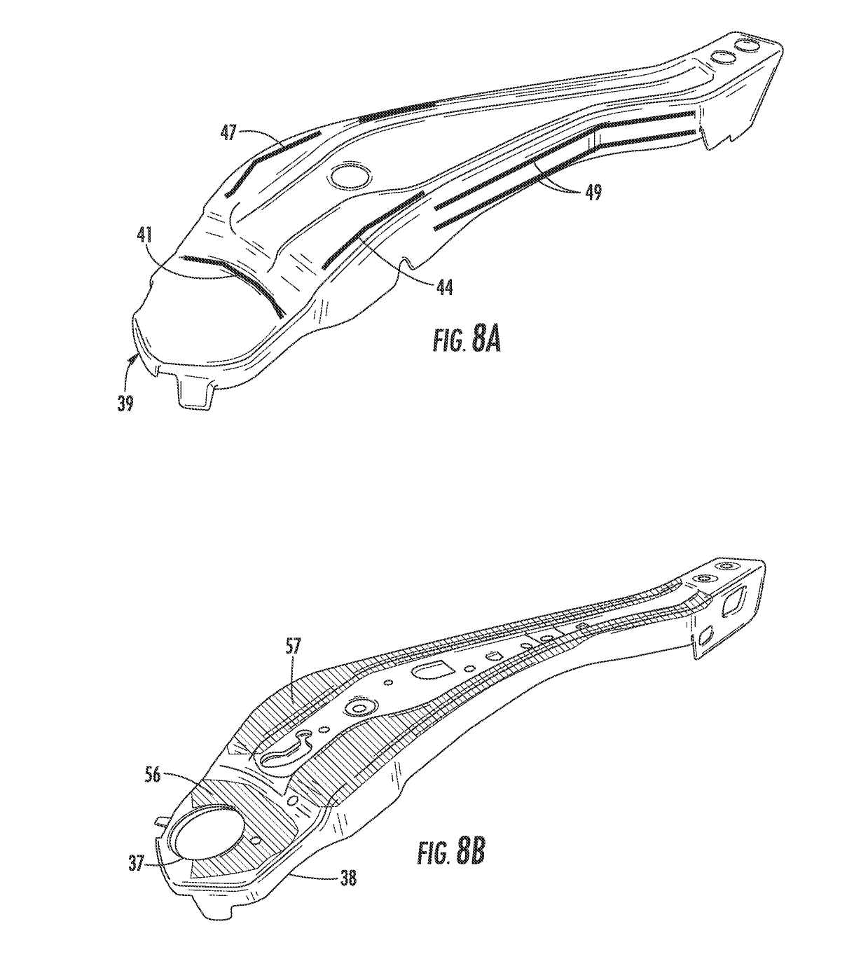

FIG. 8A shows a recliner frame side member preliminarily stamped intermediate component 39 of a vehicle seat. The preliminarily stamped intermediate component 39 is stamped and then has selected regions 41, 47 and 49 laser-hardened. In particular, the side members have a hardened region 41 in a region near an opening 37 toward the base—near the fitting (or connection to the seat base). Hardened regions 47 are provided at raised (bent) portions and hardened regions 47 are provided at an edge region of the preliminarily stamped intermediate side component 39. Other regions are not hardened. These laser-hardened regions and non-hardened regions define load paths which are provided based on the intended or expected load of the recliner frame. This allows a selective strengthening of the seat structures, namely the side member component 38, based on selectively hardened regions. This produces strengthened regions 56 and 57 in the final stamped component 38 as shown in FIG. 8B. This provides defined and predictable and repeatable load paths. Further, the overall geometry of the side members is simplified allowing for a 30% mass decrease and related cost decrease with regard to structural/functional requirements. Further, a multi-part structure such as a multi-component side member is not required. Instead, a monolithic or single stamped part (component) is provided. During the one or more stamping steps, with the one or more laser hardening steps, one or more laser softening steps (to improve formability) may be provided so as to provide a deeper draw with a subsequent stamping and to provide a better geometry or a desired geometry for the final part.

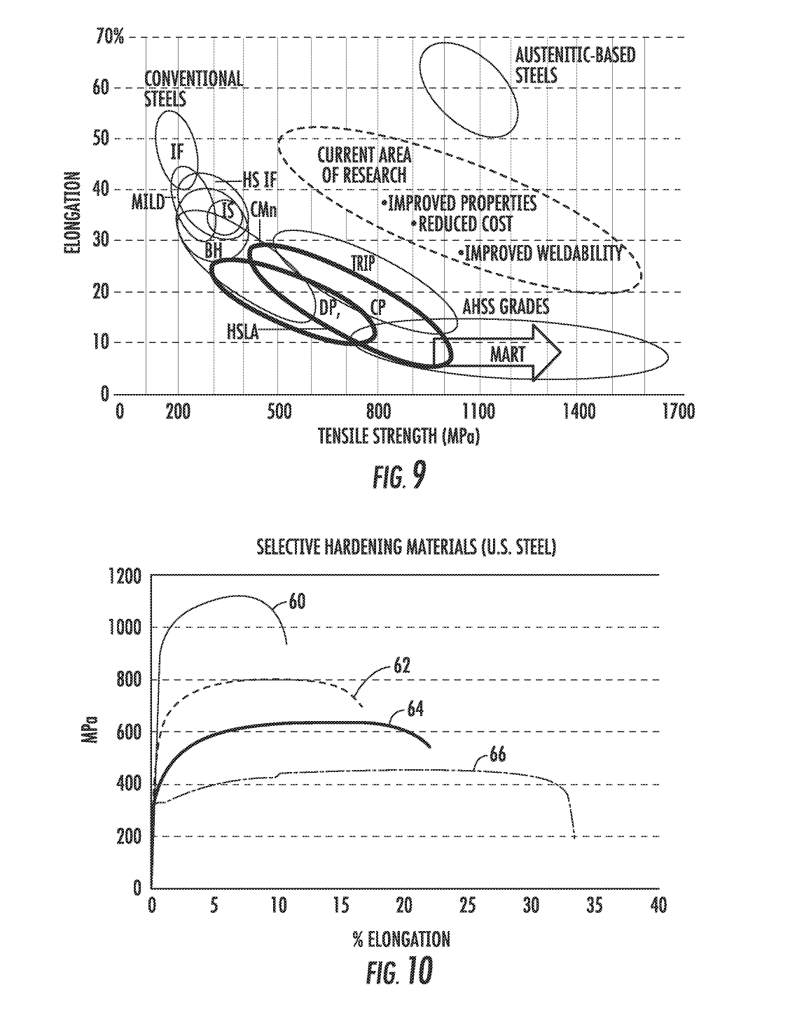

FIG. 9 shows tensile strength and elongation properties relative to various types of metal heat treatments, forming and quenching that result in various steel materials. The relationship between temperature and time and resulting properties of the metal provides various attributes. A region of interest is indicated (current area of research) that provides particularly advantageous properties using the laser hardening and stamping of the invention. These improved properties are provided with reduced costs and result in improved weldability. The hardening of particular steels is shown in the diagram of FIG. 10, wherein steel material 60 is US Steel 980 TBF (UTS (MPa) 1119.5; Yield (Mpa) 977.4; Elongation 11%, steel material 62 is US Steel 780 YHISI (UTS (MPa) 801.7; Yield (Mpa) 511.2; Elongation 17%, steel material 64 is US Steel 590 Y (UTS (MPa) 639.4; Yield (Mpa) 347.2; Elongation 22% and steel material 66 is US Steel 440W (UTS (MPa) 454.8; Yield (MPa) 320.0; Elongation 33%. According to a further aspect of the invention, selective laser heating is used in combination with stages of stamping, to provide not only hardening but also to change the formability of the metal. In particular, with reference again to FIG. 1, before or after a preliminary stamping, the steel blank or the preliminarily stamped intermediate component is subjected to a laser heating of selected areas of the steel blank or preliminarily stamped intermediate component. This affects the formability of the metal, in the selectively heated areas, for stamping. This allows a softening of selected regions of either the steel blank or the preliminarily stamped intermediate component, by application of the laser to the selected regions, to heat the selective regions. This allows for a deeper drawing and allows any of the stamping procedures to achieve different and better geometries. In particular, the invention may employ both laser hardening, subsequent to one or more preliminary stamping procedures, and employ a step for softening the material, namely a heating via the application of a laser to soften metal for better formability, either prior to the initial stamping or subsequent to one or more preliminary stamping procedures and prior to a next stamping procedure or prior to a final stamping procedure.

The laser hardening may be following one or a series of stamping steps and may be provided in combination with subsequent laser hardening steps to selectively stamp and harden particular regions of the preliminarily stamped intermediate component. This may be combined with a selective laser softening, by heating selective regions, in combination with one or a series of stamping steps. In particular, with regard to step 3, laser hardening may be provided in combination with laser softening wherein the laser softening allows for a deeper drawing and results in better geometries or more complex geometries upon being subjected to the next stamping step.

The power of the laser, the region of laser application, and other laser parameters may be selected along with a selection of the cooling and timing of the heat application, stamping and quenching. The selection of laser parameters, such as power, and the selection of other parameters are considered based on the properties of metal, for example, the properties of the metal relative to heating and quenching rates may be considered with regard to selecting the parameters to provide the eventual product having the desired characteristics. The selection of various parameters is considered in combination with a selection of the region of the steel blank, based on the final geometry and/or preliminarily stamped intermediate component, to provide the softening (for formability) and hardening as needed. The selection of regions for softening and hardening and quenching provides special and particular geometries as well as providing a resulting part with predetermined regions of hardness as well as other qualities (for example buckle zones or the like for defined deformation during an automotive crash or the like). In particular, according to the invention, not all of the final component needs to be subjected to the laser heating treatment. Some of the part may be heated for improved formability, just prior to a stamping stage. Other parts may be subjected to laser heating to harden the part as described. These laser heating steps are combined with stamping steps in which each stage provides a different form based on the stamping (and the tool provided) to achieve the final product.

The selective hardening provides the ability to define load paths in the final product. The designer may direct loads for normal use and also direct loads with regard to a crash situation or the like. Buckle areas (defined deformation regions under predetermined loads) may be defined such that the final part provides a defined buckling or deformation based on particular load situations. By selectively hardening some regions prior to or following stamping, the final product (component) may be provided with repeatable and reliable crumple or buckle regions that allow for a repeatable and reliable deformation of the part, during defined load situations.

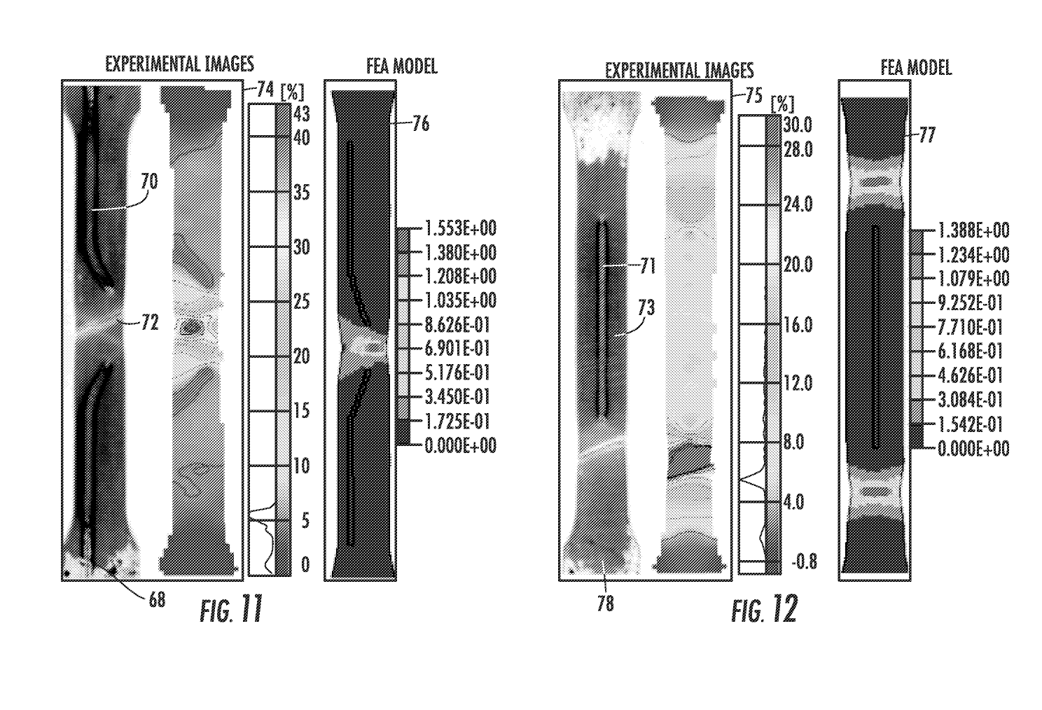

FIG. 11 shows the results of a diode laser heat treatment of a base material with a single laser-hardened strip or weld 70 that is interrupted in a central region 72 of a sample 68. The actual characteristics 74 and characteristics 76 predicted by the finite element analysis (FEA) model are shown to the right of the sample. FIG. 11 shows that the load path may be managed with a single laser interrupted treatment strip (weld) 70 effectively diverting a failure away from the selectively hardening region (welded section). This produced an area of increased hardness corresponding to the heat affected area whereas the remainder of the base material retained its original characteristics.

FIG. 12 shows the results of a diode laser heat treatment of a base material with a single laser-hardened strip or weld 71 that is in a central region 73 of the sample 78. The actual characteristics 75 and characteristics 77 predicted by the FEA model are shown to the right of the sample. FIG. 12 shows that the load path may be managed with a single laser treatment strip (weld) 70 effectively diverting a failure away from the selectively hardening region (welded section). This produced an area of increased hardness corresponding to the heat affected area whereas the remainder of the base material retained its original characteristics.

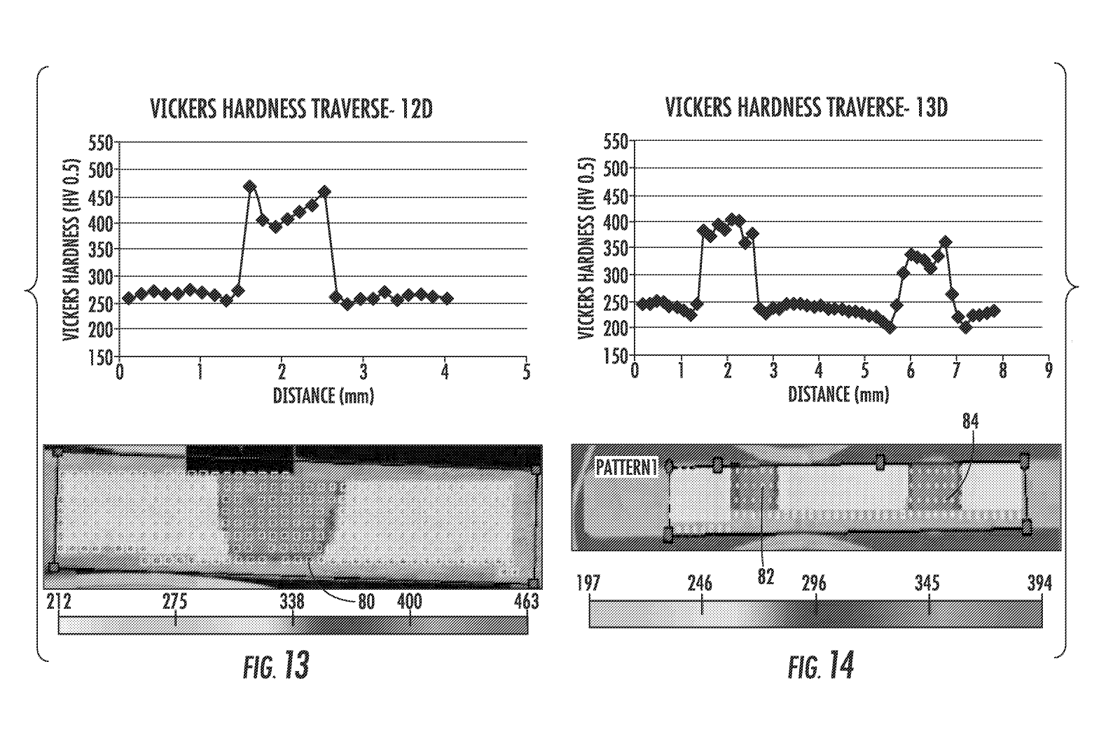

The upper portion of FIG. 13 shows a variation in hardness in a laser heat treated sample, showing the relationship of the hardness of the base material relative to the hardness of the heat affected region. The base material was subjected to a laser heating with a Trumpf Laser 6002 having a laser spot size of 600 microns, Highyag optics, a 300 mm focus, 200 mm collimator, 400 microns fiber, 3000 mm/min travel rate and 1200 W power. The lower portion of FIG. 13 shows the heat affected region 80 relative the diagram. The hardness of the sample has been significantly increased in the heat treated (laser-hardened) region 80.

The upper portion of FIG. 14 shows a variation in hardness in a laser heat treated sample, showing the relationship of the hardness of the base material relative to the hardness of two heat affected regions. The lower portion of FIG. 14 shows the two heat affected regions 82 and 84 relative to the hardness diagram. The hardness of the sample has been significantly increased in each of the heat treated regions.

The selective laser heat treatment allows for a selective hardening to provide local hardened regions and to also maintain regions with the original characteristics of the base metal. The base material properties may be selectively altered or retained to change the strength and hardness and to selectively direct the load to provide predefined load paths. The load paths may be formed based on strengthened areas and adjacent areas that may be potential buckle areas.

While specific embodiments of the invention have been shown and described in detail to illustrate the application of the principles of the invention, it will be understood that the invention may be embodied otherwise without departing from such principles.

### LIST OF REFERENCE NUMBERS

1 insert steel blank
2 preliminary stamping
3 laser hardening
3′ laser hardening in tool
3a optional oil cooling operation
4 final stamping
5 eject part
10 steel blank
14 stamping press
14′ stamping press with laser outlet
16 stamping die (tooling)
18 finished component part
20 laser outlet
22 preliminarily stamped intermediate component
23 laser
24 in-die quenching
25 oil
30 vehicle seat B bracket
32 track rail component
33 opening
34
36 recliner portion
37 opening
38 side member
39 preliminarily stamped intermediate side member component
40 opening
41 laser hardened region
42 laser hardened region
44 laser hardened region
45 laser hardened region
46 laser hardened region
47 laser hardened region
48 laser hardened region
49 laser hardened region
50 lift sector
51 supported end
52 teeth
53 laser hardened region
54 laser hardened region
55 strengthened region
56 strengthened region
57 strengthened region
68 sample with single interrupted single laser treatment strip (weld)
70 a single laser treatment strip (weld)
71 laser-hardened strip or weld 71
72 central region
73 central region
74 actual characteristics
76 characteristics predicted by the FEA model
75 actual characteristics
77 characteristics predicted by the FEA model
78 sample single uninterrupted laser treatment strip
80 heat affected (laser-hardened) region
82 heat affected (laser-hardened) region
84 heat affected (laser-hardened) region

1. A component formation process comprising the steps of:
providing a steel blank;
preliminarily stamping the steel blank using a stamping press to form a preliminarily stamped intermediate component;
laser hardening the preliminarily stamped intermediate component in selected regions of the stamped component;
subsequent to the step of laser hardening, stamping the preliminarily stamped intermediate component to form a stamped component; and
ejecting the stamped component from the stamping press as a stamped component with selectively hardened regions.

2. A process according to claim 1, wherein the laser hardening is provided by directing a laser beam at the preliminarily stamped intermediate component at a laser hardening station that is a separate station from the stamping press.

3. A process according to claim 1, wherein the step of stamping the preliminarily stamped intermediate component to form the stamped component is carried out in a stamping press that is different from the stamping press used for preliminarily stamping the steel blank.

4. A process according to claim 1, wherein the laser hardening is provided by directing a laser beam at the preliminarily stamped intermediate component with a laser output in or supported adjacent to a tool of the stamping press.

5. A process according to claim 4, wherein the stamping press comprises additional laser outlets in the tool of the stamping press, the laser outlets being supplied by one or more lasers.

6. A process according to claim 1, wherein subsequent to the step of laser hardening the preliminarily stamped intermediate component is subjected to an oil quenching operation.

7. A process according to claim 6, wherein the oil quenching operation comprises selectively applying quenching oil to the regions that were subjected to the laser hardening.

8. A process according to claim 4, wherein the step of stamping the preliminarily stamped intermediate component to form the stamped component is followed by quenching, with the stamped component in a die of the stamping press.

9. A process according to claim 1, wherein the stamped component is one of:
an automotive seat recliner side member;
an automotive seat recliner B bracket;
an automotive seat track rail; and
RR structural components, recliner and tracks components.

10. A process according to claim 1, wherein the selectively hardened regions are at or adjacent to bend portions, openings and regions to be subjected to greater loads than adjacent non-hardened regions with the selectively hardened regions defining a predetermined load path.

11. A process according to claim 1, wherein at least one of the steel blank and the preliminarily stamped intermediate component is subjected to a laser heating to change a formability of said at least one of the steel blank and the preliminarily stamped intermediate component, wherein the laser beam is directed at selective regions of said at least one of the steel blank and the preliminarily stamped intermediate component to soften the selected region prior to a subsequent stamping of said at least one of the steel blank and the preliminarily stamped intermediate component.

12. A process according to claim 1, wherein prior to at least one of said step of preliminarily stamping the steel blank and stamping the preliminarily stamped intermediate component directing a laser beam at a selected region of at least one of the steel blank and the preliminarily stamped intermediate component to soften the selected region of said at least one of the steel blank and the preliminarily stamped intermediate component and proceeding with said at least one of said step of said preliminarily stamping the steel blank and stamping the selected region of said at least one of the steel blank and the preliminarily stamped intermediate component is softened.

13. A process according to claim 1, wherein a plurality of laser hardening steps are each followed by one of a plurality of stamping steps.

14. A process according to claim 1, wherein a plurality of laser softening steps each precede one of a plurality of stamping steps.

15. An automotive component formed by a process comprising the steps of:
providing a steel blank;
preliminarily stamping the steel blank using a stamping press to form a preliminarily stamped intermediate component;
laser hardening the preliminarily stamped intermediate component in selected regions of the preliminarily stamped intermediate component;
subsequent to the step of laser hardening, stamping the laser hardened preliminarily stamped intermediate component to form a stamped component; and
ejecting the stamped component from the stamping press as a stamped component with selectively hardened regions.

16. A stamped steel or steel alloy automotive structural component comprising:
one or more edges and at least one of:
a bend portion with a selectively laser-hardened region at or adjacent to the bend portion;
an opening passing through the stamped steel structural component with a selectively laser-hardened region at or adjacent to the opening; and
a load path region with selectively laser-hardened region at or adjacent to the load path region, the laser-hardened region defining a predetermined load path in the load path region, wherein the laser hardened region is provided by laser hardening a preliminarily stamped intermediate component in selected regions of the preliminarily stamped intermediate component and subsequently subjecting the laser hardened preliminarily stamped intermediate component to a further the stamping to form the structural component.

17. A stamped steel or steel alloy automotive structural component according to claim 16, wherein the laser-hardened region is adjacent to at least one region that has not been subjected to laser hardening.

18. A stamped steel or steel alloy automotive structural component according to claim 16, wherein regions adjacent to the selectively laser-hardened region define one or more deformation zones which deform in a predetermined manner upon being subjected to a predetermined load.

19. A stamped steel or steel alloy automotive structural component according to claim 16, wherein the load path region is at the laser-hardened region and extends between support locations of the component.

20. A process according to claim 4, wherein the laser hardening is provided in or at the tool and the stamped component is subjected to the preliminary stamping, the laser hardening and the subsequent stamping of the preliminarily stamped and laser hardened intermediate component within the stamping press with the laser outlet.
